(19) United States
(12) Patent Application Publication
(10) Pub. No.: US 2023/0335916 A1
(43) Pub. Date: Oct. 19, 2023

(54) ANTENNA DEVICE

(71) Applicant: Molex, LLC, Lisle, IL (US)

(72) Inventors: Ping Zhang, Shanghai (CN); Guang-Yong Zhong, Shanghai (CN); Hai Liu, Shanghai (CN); Chun-Xia Zhang, Shanghai (CN)

(21) Appl. No.: 18/132,442

(22) Filed: Apr. 10, 2023

(30) Foreign Application Priority Data
Apr. 18, 2022 (CN) 202210403812.5

(51) Int. Cl. H01Q 1/22; H01Q 1/24; H01Q 21/00; H01Q 1/50; H01Q 1/42

(52) U.S. Cl. CPC H01Q 21/0006; H01Q 1/2291; H01Q 1/24; H01Q 1/42; H01Q 1/50

(57) ABSTRACT

An antenna device is provided to include an antenna radiating assembly, the antenna radiating assembly includes: a first metal plate; at least two antennas including a first mobile communication antenna and a second mobile communication antenna, the first mobile communication antenna and the second mobile communication antenna are respectively perpendicularly provided to a surface of the first metal plate, and the first mobile communication antenna and the second mobile communication antenna are perpendicular to each other; a second metal plate extending from a side of the first metal plate toward the first mobile communication antenna and the second mobile communication antenna. So a small dimension antenna device is provided to consider an antenna dimension and antenna performance at the same time, employ a three-dimensional antenna structure to reduce the dimension, at the same time assure isolation degree between two mobile communication antennas and promote antenna performance.

### RELATED APPLICATIONS

This application claims priority to Chinese Patent Application Serial No. 202210403812.5, filed Apr. 18, 2022, which is incorporated herein by reference in its entirety.

### TECHNICAL FIELD

The present disclosure relates to the field of communication technology, and specifically relates to an antenna device.

### BACKGROUND

As the market’s demand for communication continuously increases, the fifth-generation (5G) mobile communication is booming and popularized rapidly. The demand for integration of mobile communication, WIFI communication, and global positioning and navigation from automotive, medical, and Internet of Things devices is becoming more and wider. Therefore, the requirements of the above multiple communication modes propose new challenge to the design of the antenna.

In order to improve the communication capacity, data transferring speed and anti-multipath fading capability of the communication system, a multiple-input multiple-output system (abbreviated as MIMO) which uses multiple antennas to perform communications at the same time at each of a transmitting end and a receiving end become a key technology.

The MIMO communication of a mobile communication terminal requires at least two antennas (a primary antenna and an auxiliary antenna), in order to ensure an isolation degree between the primary antenna and the auxiliary antenna, dimensions of the antennas are usually required to be as large as possible. However, a dimension of the mobile communication terminal is relatively small, even for vehicle-mounted antennas, due to the limitation of the mounting space on the vehicle, dimensions of the antennas are required to be as small as possible. In addition, because 5G antennas need to be compatible with 2G, 3G and Sub 6G frequency bands, a bandwidth of the antennas is relatively wide, and the dimensions of the antennas need to be increased. In this way, there is a confliction. On one hand, the antennas need larger dimensions for good performance, and on the other hand, the dimensions of the antennas are required to be as small as possible in practical use. However, the current 5G MIMO antenna system is either large in dimension or makes the primary antenna and the auxiliary antenna divided into two independent antennas and mounted separately. But this will increase the overall manufacturing cost and mounting cost of the antennas. Otherwise, the dimensions of the antennas are reduced by reducing performance of the antennas, but this approach will greatly reduce the isolation degree between the primary antenna and auxiliary antenna of the MIMO antenna system, which makes the overall data throughput of the communication system difficult to be increased.

### SUMMARY

In view of the problem in the existing technology, an object of the present disclosure is to provide a small dimension antenna device which may consider an antenna dimension and antenna performance at the same time, employ a three-dimensional antenna structure to reduce the dimension, at the same time assure isolation degree between two mobile communication antennas and promote antenna performance.

An embodiment of the present disclosure provides an antenna device comprising an antenna radiating assembly, the antenna radiating assembly comprises: a first metal plate; at least two antennas comprising a first mobile communication antenna and a second mobile communication antenna, the first mobile communication antenna and the second mobile communication antenna are respectively perpendicularly provided to a surface of the first metal plate, and the first mobile communication antenna and the second mobile communication antenna are perpendicular to each other; a second metal plate extending from a side of the first metal plate toward the first mobile communication antenna and the second mobile communication antenna.

In some embodiments, the first mobile communication antenna and the second mobile communication antenna are a first LTE/5G antenna and a second LTE/5G antenna respectively.

In some embodiments, the antennas further comprises a first WIFI antenna and a second WIFI antenna which are perpendicularly provided to the surface of the first metal plate respectively.

In some embodiments, the first WIFI antenna is parallel to the second WIFI antenna.

In some embodiments, the antennas further comprise a GNSS antenna, the GNSS antenna comprises a GNSS circuit board which is provided to a first surface of the first metal plate and a GNSS antenna body which is provided to a second surface of the first metal plate.

In some embodiments, the antenna device further comprises at least two coaxial cables, each coaxial cable corresponds to one of the antennas, a first end of the coaxial cable is connected to a radio frequency connector, a second end of the coaxial cable is electrically connected to the corresponding antenna.

In some embodiments, the coaxial cable comprises an internal conductor and an external conductor, the internal conductor of the coaxial cable is soldered to a feed soldering pad of the corresponding antenna, the external conductor of the coaxial cable is soldered to the first metal plate.

In some embodiments, the antenna device further comprises an outer casing, the antenna radiating assembly is accommodate inside the outer casing, a surface of the outer casing is provided with a rubber filler which allows the coaxial cables to pass through.

In some embodiments, the first mobile communication antenna and the second mobile communication antenna are PCB antennas or metal stamping antennas.

In some embodiments, the first mobile communication antenna and the second mobile communication antenna each are a monopole plus parasitic antenna.

In some embodiments, the first WIFI antenna and the second WIFI antenna are PCB antennas or metal stamping antennas.

In some embodiments, the first WIFI antenna and the second WIFI antenna each are an IFA plus parasitic antenna.

In some embodiments, the first metal plate comprises a first side edge, a second side edge, a third side edge and a fourth side edge, the first side edge is perpendicular to the second side edge; the first mobile communication antenna and the second mobile communication antenna are provided to the first side edge and the second side edge respectively; the first WIFI antenna and the second WIFI antenna are provided to the third side edge respectively; the second metal plate extends the fourth side edge toward the first side edge and the second side edge.

In some embodiments, the first mobile communication antenna, the second mobile communication antenna, the first WIFI antenna and the second WIFI antenna are provided to a first surface of the first metal plate respectively, the second metal plate is at least partially suspended relative to the first surface of the first metal plate.

In some embodiments, the first WIFI antenna, the second WIFI antenna and the second metal plate and the first metal plate are integrally formed.

An embodiment of the present disclosure further provides an antenna device comprising antenna radiating assembly, the antenna radiating assembly comprises: a first metal plate comprising a first side edge, a second side edge, a third side edge and a fourth side edge; a second metal plate integrally formed with the first metal plate and extending from the fourth side edge toward the first side edge and the second side edge; a plurality of antennas comprising: a first mobile communication antenna provided to the first side edge of the first metal plate; a second mobile communication antenna provided to the second side edge of the first metal plate; a first WIFI antenna and a second WIFI antenna respectively integrally formed with the first metal plate and bending inwardly from the third side edge of the first metal plate and extending to form metal stamping antennas.

In some embodiments, the first mobile communication antenna and the second mobile communication antenna are a first LTE/5G antenna and a second LTE/5G antenna respectively.

In some embodiments, the second metal plate comprises a connecting portion and a paralleling portion, the connecting portion is perpendicularly connected to the first metal plate, so as to make the paralleling portion suspended relative to a first surface of the first metal plate.

In some embodiments, the first mobile communication antenna and the second mobile communication antenna are PCB antennas respectively, and are perpendicular to each other.

In some embodiments, the first WIFI antenna and the second WIFI antenna are parallel to each other.

In some embodiments, the first mobile communication antenna and the second mobile communication antenna each are a monopole plus parasitic antenna; the first WIFI antenna and the second WIFI antenna each are an IFA plus parasitic antenna.

In some embodiments, the antenna further comprises a GNSS antenna, the GNSS antenna comprises a GNSS circuit board which is provided to a first surface of the first metal plate and a GNSS antenna body which is provided to a second surface of the first metal plate.

In some embodiments, the antenna device further comprises a plurality of coaxial cables, each coaxial cable corresponds to the corresponding antenna, a first end of the coaxial cable is connected to a radio frequency connector, a second end of the coaxial cable is electrically connected to the corresponding antenna; the coaxial cable comprises an internal conductor and an external conductor, the internal conductor of the coaxial cable is soldered to a feed soldering pad of the corresponding antenna, the external conductor of the coaxial cable is soldered to the first metal plate.

In some embodiments, the antenna device further comprises an outer casing, the antenna radiating assembly is accommodated inside the outer casing, a surface of the outer casing is provided with a rubber filler which allows the coaxial cables to pass through.

The antenna device provided by the present disclosure has following advantages: in the present disclosure, by the metal plates and the mobile communication antennas are reasonably arranged, it is beneficial to promote isolation degree between the two mobile communication antennas and promote the overall data throughput of the antenna device, and by adding the extending ground on a basis of the antenna ground, it is beneficial to widen lower frequency bandwidth, at the same time, the structural arrangement of the antenna device is beneficial to obtain a smaller dimension, so that antenna dimension and antenna performance are considered at the same time.

### BRIEF DESCRIPTION OF THE DRAWINGS

Other features, objectives and advantages of the present disclosure will become more apparent by reviewing the detailed description of a non-limiting embodiment with reference to the drawings.

FIG. 1 and FIG. 2 are structural schematic views of an antenna device of an embodiment of the present disclosure viewed from different angles.

FIG. 3 is an exploded view of the antenna device of the embodiment of the present disclosure.

FIG. 4 is a schematic view of an antenna radiating assembly cooperating with coaxial cables of the embodiment of the present disclosure.

FIG. 5 is a bottom view of the antenna radiating assembly of the embodiment of the present disclosure.

FIG. 6 is a top view of the antenna radiating assembly of the embodiment of the present disclosure.

FIG. 7 to FIG. 9 are schematic views of PCB antennas and metal stamping antennas of the embodiment of the present disclosure.

FIG. 10 and FIG. 11 are schematic views of LTE/5G antennas and a metal plate of the embodiment of the present disclosure cooperating with each other.

FIG. 12 is a schematic view of a GNSS antenna of the embodiment of the present disclosure.

FIG. 13 is a schematic view of the GNSS antenna and the coaxial cable of the embodiment of the present disclosure cooperating with each other.

### DETAILED DESCRIPTION OF THE PREFERRED EMBODIMENTS

An exemplary embodiment will now be described more comprehensively with reference to the drawings. However, the exemplary embodiment can be implemented in various forms and should not be understood as limited to the embodiment described herein; on the contrary, providing the embodiment will make the present disclosure comprehensive and complete, and will comprehensively convey the concept of the exemplary embodiment to a person skilled in the art. The same reference numerals in the figures represent the same or similar structures, so the repeated description of them will be omitted. “Or” in the specification may mean “and” or “or”. Although the terms “up”, “down”, “between” and the like may be used in the specification to describe different exemplary features and elements of the present disclosure, these terms are used herein for convenience only, for example, according to the orientation of the example described in the drawings. Nothing in this specification should be understood as requiring a specific three-dimensional direction of the structure to fall within the scope of the present disclosure. Although “first” or “second” are used to represent some features in the specification, they are only used to represent action, but are not used as a limitation of the number and importance of specific features.

The present disclosure provides an antenna device which employs a three-dimensional antenna structure to reduce dimension, at the same time assures isolation degree between two mobile communication antennas and promotes antenna performance. Here, in an implementing manner, the antenna device includes antenna radiating assembly, the antenna radiating assembly includes a first metal plate, at least two antennas and a second metal plate. The first metal plate is used as an antenna ground. The antennas at least include a first mobile communication antenna and a second mobile communication antenna, the first mobile communication antenna and the second mobile communication antenna are perpendicularly provided to a surface of the first metal plate respectively, and the first mobile communication antenna and the second mobile communication antenna are perpendicular to each other. The second metal plate extends from a side of the first metal plate toward the first mobile communication antenna and the second mobile communication antenna. The second metal plate is used as an extending ground. Therefore, the present disclosure makes a structure design of the antenna radiating assembly, employs a three-dimensional antenna structure, which is beneficial to reduce a volume of the antenna device, that the first mobile communication antenna and the second mobile communication antenna are perpendicularly provided on the antenna ground and perpendicular to each other may assure good isolation degree within the full frequency band, is beneficial to reduce the volume of antenna device, at the same time assures better data processing performance of the antenna device. By provision of the extending ground, it beneficial to widen lower frequency bandwidth, the first mobile communication antenna, the second mobile communication antenna, the antenna ground and the extending ground action together to generate a wide bandwidth antenna.

In another implementing manner, the antenna device includes antenna radiating assembly, the antenna radiating assembly includes a first metal plate, a second metal plate and at least two antennas. The first metal plate is used as an antenna ground, includes a first side edge, a second side edge, a third side edge and a fourth side edge. The second metal plate is integrally formed with the first metal plate, and extends from the fourth side edge toward the first side edge and the second side edge, the second metal plate is used as an extending ground. The antennas at least include a first mobile communication antenna which is provided to the first side edge of the first metal plate and a second mobile communication antenna which is provided to the second side edge of the first metal plate, and a first WIFI antenna and a second WIFI antenna which are integrally formed with the first metal plate respectively and bend inwardly from the third side edge of the first metal plate and extend to form metal stamping antennas. The present disclosure makes a structure design of the antenna radiating assembly so that the first mobile communication antenna and the second mobile communication antenna are provided to the two adjacent side edges of the antenna ground respectively and the WIFI antennas, the extending ground and the antenna ground are integrally formed, facilitating assembling of the antenna device, and cost may be lowered, employing the three-dimensional antenna structure is beneficial to reduce a volume of the antenna device, at the same time may assure isolation degree between the two mobile communication antennas, is beneficial to reduce the volume of the antenna device, at the same time assures better data processing performance of the antenna device. By provision of the extending ground, it is beneficial to widen lower frequency bandwidth, the first mobile communication antenna, the second mobile communication antenna, the antenna ground and extending ground action together to generate a wide bandwidth antenna.

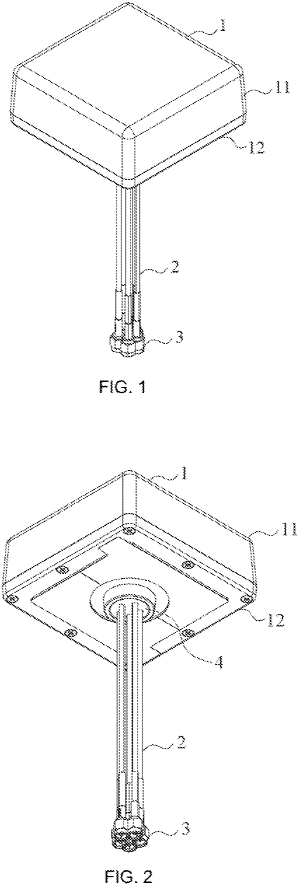

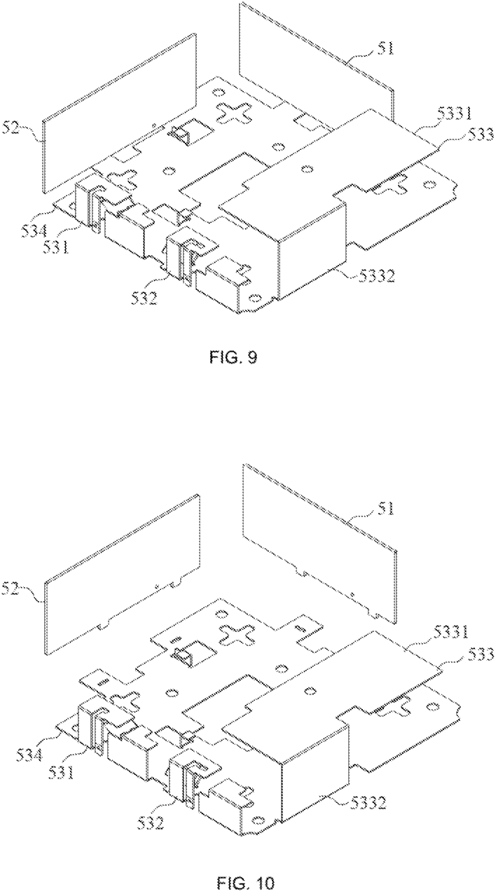

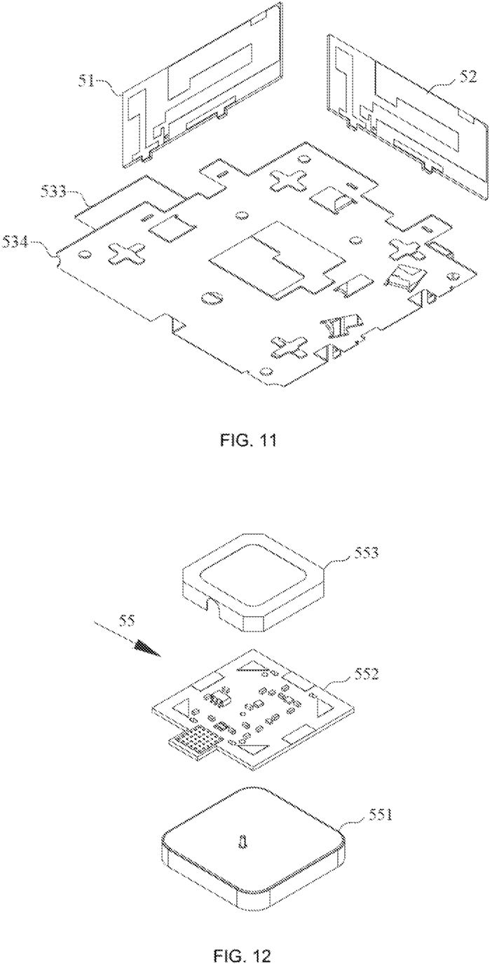

Hereinafter in combination with FIG. 1 to FIG. 13, a specific structure of the antenna device of the present disclosure is described by means of one specific embodiment. It may be understood that, the drawings and the following description are only intended to explain the present disclosure more clearly, and are not restrictive. The present disclosure can also delete or replace one or more of features, or add other features and the like.

As shown in FIG. 1 to FIG. 3, the antenna device includes an outer casing 1, the outer casing 1 includes a casing cover 11 and a bottom plate 12 which together may encircle to form one accommodating space to accommodate an antenna radiating assembly 5. In the embodiment, an external dimension of the outer casing 1 is 95 mm×95 mm×38 mm, however the present disclosure is not limited thereto, other dimensions also may be employed, a material of the outer casing 1 is PC (polycarbonate), ABS (acrylonitrile-butadiene-styrene plastics) or other non-metal material. The antenna device further includes an antenna radiating assembly 5 which is positioned inside the outer casing 1 and at least two coaxial cables 2, the antenna radiating assembly 5 includes at least two antennas. The coaxial cables 2 pass through a through hole at a center of the bottom plate 12, a rubber filler 4 is provided to the through hole, the rubber filler 4 is used to fix the coaxial cables 2. One end of each coaxial cable 2 is connected to one corresponding antenna, the other end of each coaxial cable 2 is connected to a radio frequency connector 3.

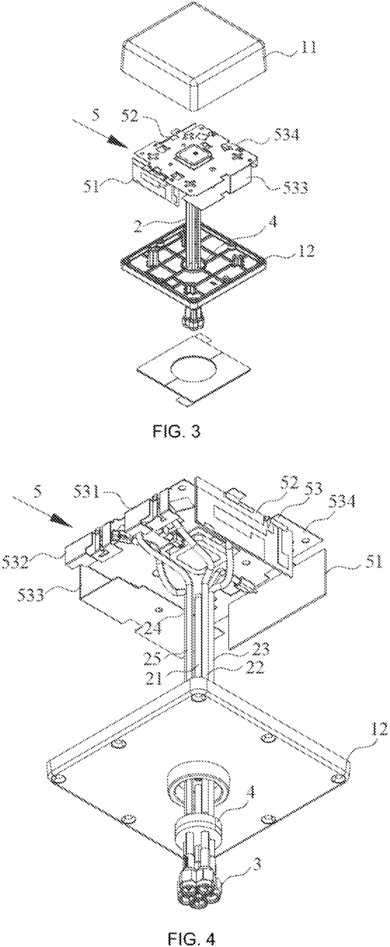

As shown in FIG. 3 to FIG. 6, in the embodiment, the antenna radiating assembly 5 includes a first metal plate which is defined as an antenna ground 534, a second metal plate which is defined as an extending ground 533 and five antennas which are a first mobile communication antenna, a second mobile communication antenna, a first WIFI antenna, a second WIFI antenna and a GNSS (Global Navigation Satellite System) antenna, so that the antenna radiating assembly 5 forms one multiple-in-one antenna having various communication functions. The coaxial cables 2 correspondingly have five coaxial cables 2. In the embodiment, the coaxial cable 2 is a 50 Ohm radio frequency coaxial cable 2. For example, the radio frequency connector 3 may employ a FAKRA connector, a SMA connector and TNC connector and the like. The coaxial cable 2 includes an internal conductor and an external conductor, the internal conductor of the coaxial cable 2 is soldered to a feed soldering pad of the corresponding antenna (hereinafter a corresponding relationship between each coaxial cable 2 and the antenna is specifically introduced), the external conductor of the coaxial cable 2 in form of braid is soldered to the antenna ground 534. In other implementing manners, the antenna radiating assembly 5 may include other number of antennas, for example only includes the first mobile communication antenna and the second mobile communication antenna, or only includes the first WIFI antenna, the second WIFI antenna, the first mobile communication antenna and the second mobile communication antenna, or includes other antenna which is not listed herein.

In the embodiment, the first mobile communication antenna and the second mobile communication antenna are a first LTE/5G antenna and a second LTE/5G antenna respectively, specifically, the first LTE/5G antenna is a LTE/5G primary antenna 51, the second LTE/5G antenna is a LTE/5G auxiliary antenna 52. A frequency range of the LTE/5G primary antenna 51 is 698-960 MHz/1710-2690 MHz/3300-4200/4400-5000 MHz, employs an antenna form of monopole plus parasitic radiating unit, a frequency range of the LTE/5G auxiliary antenna 52 is 698-960 MHz/1710-2690 MHz/3300-4200/4400-5000 MHz, employs an antenna form of monopole plus parasitic radiating unit. However, the present disclosure is not limited thereto, in other altemative implementing manners, the LTE/5G primary antenna 51 and/or the LTE/5G auxiliary antenna 52 also may employ other type of antenna types. LTE refers to Long Term Evolution, 5G refers to the fifth-generation mobile communication technology.

In the embodiment, the first WIFI antenna and the second WIFI antenna are a WIFI primary antenna 531 and a WIFI auxiliary antenna 532 respectively. A frequency range of the WIFI primary antenna 531 is 2400-2485 MHz/5150-5850 MHz, employs an antenna form of IFA (inverted-F antenna) plus parasitic radiating unit. A frequency range of the WIFI auxiliary antenna 532 is 2400-2485 MHz/5150-5850 MHz, employ an antenna form of IFA plus parasitic radiating unit. However, the present disclosure is not limited thereto, in other altemative implementing manners, the WIFI primary antenna 531 and/or the WIFI auxiliary antenna 532 also may employ other type of antenna types.

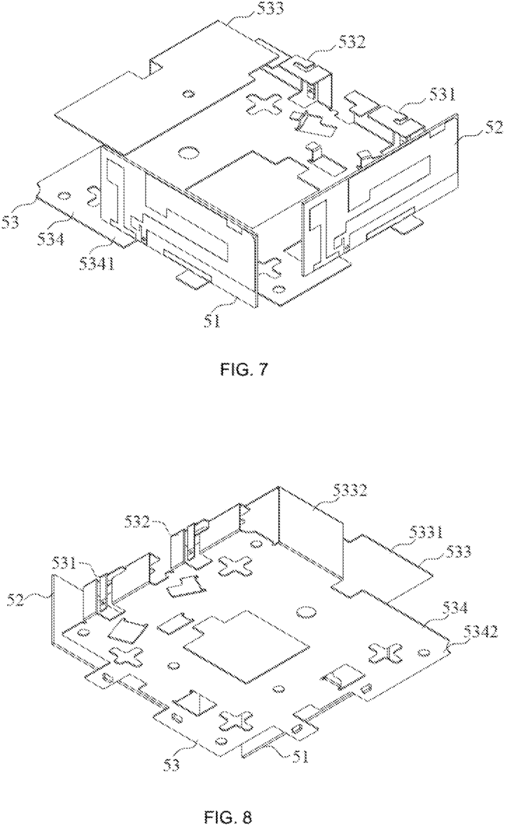

As shown in FIG. 7 to FIG. 11, in the embodiment, the antenna ground 534, the extending ground 533, the WIFI primary antenna 531 and the WIFI auxiliary antenna 532 is an integrally formed metal plate, that is, form an integral-type metal plate 53, thereby facilitating assembling of the antenna radiating assembly 5, and cost may be lowered. The WIFI primary antenna 531 and the WIFI auxiliary antenna 532 cooperate with the antenna ground 534 to form metal stamping antennas (Stamping antennas). The LTE/5G primary antenna 51 and the LTE/5G auxiliary antenna 52 each employ a form of PCB (Printed Circuit Board) antenna. The antenna ground 534 includes a first side edge, a second side edge, a third side edge and a fourth side edge. The first side edge and the second side edge of the antenna ground 534 are perpendicular to each other. The LTE/5G primary antenna 51 and the LTE/5G auxiliary antenna 52 are perpendicularly provided to the first side edge and the second side edge of the antenna ground 534 respectively, the LTE/5G primary antenna 51 and the LTE/5G auxiliary antenna 52 are perpendicular to each other and maintain a certain distance from each other, so that isolation degree between the LTE/5G primary antenna 51 and the LTE/5G auxiliary antenna 52 may be promoted, good isolation degree within full frequency band is assure. The WIFI primary antenna 531 and the WIFI auxiliary antenna 532 are perpendicularly provided to the third side edge of the antenna ground 534, and the WIFI primary antenna 531 and the WIFI auxiliary antenna 532 are parallel to each other. The extending ground 533 extends from the fourth side edge of the antenna ground 534 toward the LTE/5G primary antenna 51 and LTE/5G auxiliary antenna 52, that is, extends toward the first side edge and the second side edge of the antenna ground 534.

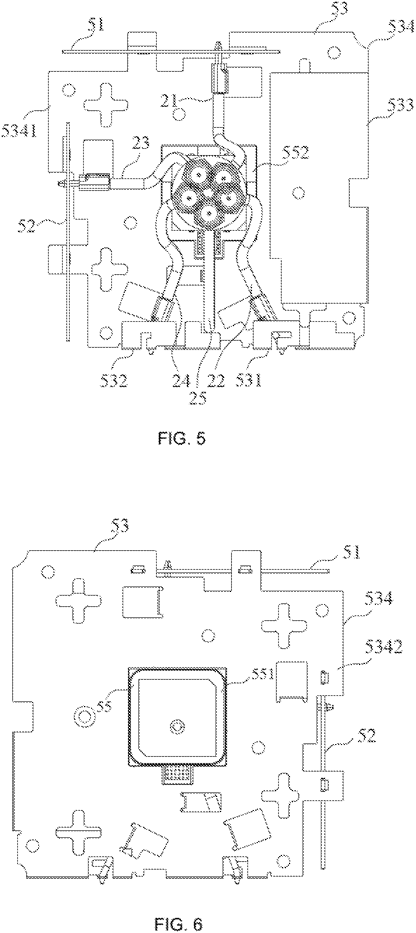

As shown in FIG. 5 to FIG. 11, in the embodiment, the antenna ground 534 includes a first surface 5341 (a side surface facing a bottom surface of the outer casing 1) and a second surface 5342 (a side surface facing top surface of the outer casing 1). The LTE/5G primary antenna 51 and the LTE/5G auxiliary antenna 52 are provided to the first surface 5341 of the antenna ground 534 respectively. The WIFI primary antenna 531 and the WIFI auxiliary antenna 532 bend inwardly from the antenna ground 534 of the third side edge and extend to form the metal stamping antennas, and are at least partially suspended relative to the first surface 5341 of the antenna ground 534. The extending ground 533 bends inwardly from the fourth side edge of the antenna ground 534 and extends, and is at least partially suspended relative to the first surface 5341 of the antenna ground 534. Specifically, the extending ground 533 includes a connecting portion 5332 and a paralleling portion 5331, the connecting portion 5332 is perpendicularly connected to the fourth side edge of the antenna ground 534, so as to make the paralleling portion 5331 suspended relative to the first surface 5341 of the antenna ground 534, a projection of the paralleling portion 5331 onto a plane where the antenna ground 534 is presented is at least partially fallen within a region of the antenna ground 534. Therefore, the extending ground 533 and the antenna ground 534 form a three-dimensional mechanism, which increases a dimension of the antenna ground 534 so that a bandwidth of the antenna device is widened.

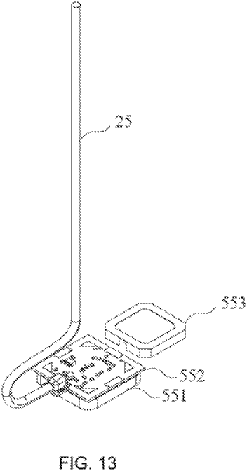

In combination with FIG. 5, FIG. 6, FIG. 12 and FIG. 13, it may be seen that, the GNSS antenna 55 includes a GNSS circuit board 552 which is provided inside the outer casing 1 and a GNSS antenna body 551 which is provided to the GNSS circuit board 552, a covering plate 553 is further provided to a side of the GNSS circuit board 552 away from the GNSS antenna body 551. The GNSS antenna body 551 is a GNSS ceramic dielectric antenna body, the GNSS circuit board 552 is a low-noise amplifier circuit board 552. The GNSS antenna 55 is an active antenna, a frequency range of the GNSS antenna 55 is 1561-1602 MHz.

As shown in FIG. 4 and FIG. 5, the coaxial cables 2 includes five coaxial cables 2, in which one end of a LTE/5G primary coaxial cable 21 is soldered to the feed soldering pad of the LTE/5G primary antenna 51, one end of a LTE/5G auxiliary coaxial cable 23 is soldered to the feed soldering pad of the LTE/5G auxiliary antenna 52, one end of a WIFI primary coaxial cable 22 is soldered to the feed soldering pad of the WIFI primary antenna 531, one end of a WIFI auxiliary coaxial cable 24 is soldered to the feed soldering pad of the WIFI auxiliary antenna 532, one end of a GNSS coaxial cable 25 is soldered to the feed soldering pad of the GNSS antenna 55. Therefore, in combination with FIG. 2 and FIG. 5, it may be seen that, one ends of the five coaxial cables 2 all may be soldered to the first surface 5341 of the antenna ground 534, and may exit from the bottom plate 12 of the outer casing 1. The present disclosure employs a three-dimensional antenna structure to solve a problem that a dimension of the existing multiple-in-one antenna with cables exiting from a bottom portion thereof is larger.

The above embodiments are described by taking that the LTE/5G primary antenna and the LTE/5G auxiliary antenna are PCB antennas and the WIFI primary antenna and the WIFI auxiliary antenna are the metal stamping antenna as example. In other altemative implementing manners, it also may be that, the LTE/5G primary antenna and the LTE/5G auxiliary antenna are metal stamping antennas and then the LTE/5G primary antenna and the LTE/5G auxiliary antenna and the antenna ground may be integrally formed, and/or the WIFI primary antenna and the WIFI auxiliary antenna are PCB antennas, all these belong to a protection scope of the present disclosure. In other implementing manners, the extending ground also may not be integrally formed with the antenna ground, but respectively employ two metal plates which are connected by welding or other manner.

The above embodiments are described by taking that the LTE/5G primary antenna and the LTE/5G auxiliary antenna each are a monopole plus parasitic antenna as example. However, the present disclosure is not limited thereto, in other altemative implementing manners, they also may employ antennas of other form, for example, the LTE/5G primary antenna and/or the LTE/5G auxiliary antenna each are an IFA plus parasitic antenna or IFA antenna and the like.

The above embodiments are described by taking that the WIFI primary antenna and the WIFI auxiliary antenna each are an IFA plus parasitic antenna form as example. However, the present disclosure is not limited thereto, in other altemative implementing manners, they also may employ antenna of other form, for example, the WIFI primary antenna and/or the WIFI auxiliary antenna each are an IFA antenna, or the WIFI primary antenna and/or the WIFI auxiliary antenna each are a monopole plus parasitic antenna form.

The above embodiments are described by taking that the mobile communication antennas each are a LTE/5G antenna as example, in other alternative implementing manners, they also may employ antennas of other type, for example, each are a 4G antenna and the like.

The above content is a further detailed description of the present disclosure in combination with the specific preferred embodiments. It cannot be considered that the specific implementation of the present disclosure is limited to these descriptions. For a person skilled in the art to which the present disclosure belongs, they can also make some simple deduction or replacement without departing from the concept of the present disclosure, which should be considered as belonging to the protection scope of the present disclosure.

What is claimed is:

1. An antenna device comprising an antenna radiating assembly, the antenna radiating assembly comprising:
a first metal plate;
at least two antennas comprising a first mobile communication antenna and a second mobile communication antenna, the first mobile communication antenna and the second mobile communication antenna being respectively perpendicularly provided to a surface of the first metal plate, and the first mobile communication antenna and the second mobile communication antenna being perpendicular to each other;
a second metal plate extending from a side of the first metal plate toward the first mobile communication antenna and the second mobile communication antenna.

2. The antenna device according to claim 1, wherein
the first mobile communication antenna and the second mobile communication antenna are a first LTE/5G antenna and a second LTE/5G antenna respectively.

3. The antenna device according to claim 1, wherein
the antennas further comprises a first WIFI antenna and a second WIFI antenna which are perpendicularly provided to the surface of the first metal plate respectively.

4. The antenna device according to claim 3, wherein
the first WIFI antenna is parallel to the second WIFI antenna.

5. The antenna device according to claim 1, wherein
the antennas further comprise a GNSS antenna, the GNSS antenna comprises a GNSS circuit board which is provided to a first surface of the first metal plate and a GNSS antenna body which is provided to a second surface of the first metal plate.

6. The antenna device according to claim 1, wherein
the antenna device further comprises at least two coaxial cables, each coaxial cable corresponds to one of the antennas, a first end of the coaxial cable is connected to a radio frequency connector, a second end of the coaxial cable is electrically connected to the corresponding antenna.

7. The antenna device according to claim 6, wherein
the coaxial cable comprises an internal conductor and an external conductor, the internal conductor of the coaxial cable is soldered to a feed soldering pad of the corresponding antenna, the external conductor of the coaxial cable is soldered to the first metal plate.

8. The antenna device according to claim 6, wherein
the antenna device further comprises an outer casing, the antenna radiating assembly is accommodate inside the outer casing, a surface of the outer casing is provided with a rubber filler which allows the coaxial cables to pass through.

9. The antenna device according to claim 1, wherein
the first mobile communication antenna and the second mobile communication antenna are PCB antennas or metal stamping antennas.

10. The antenna device according to claim 1, wherein
the first mobile communication antenna and the second mobile communication antenna each are a monopole plus parasitic antenna.

11. The antenna device according to claim 3, wherein
the first WIFI antenna and the second WIFI antenna are PCB antennas or metal stamping antennas.

12. The antenna device according to claim 3, wherein
the first WIFI antenna and the second WIFI antenna each are an IFA plus parasitic antenna.

13. The antenna device according to claim 3, wherein
the first metal plate comprises a first side edge, a second side edge, a third side edge and a fourth side edge, the first side edge is perpendicular to the second side edge;
the first mobile communication antenna and the second mobile communication antenna are provided to the first side edge and the second side edge respectively;
the first WIFI antenna and the second WIFI antenna are provided to the third side edge respectively;
the second metal plate extends the fourth side edge toward the first side edge and the second side edge.

14. The antenna device according to claim 13, wherein
the first mobile communication antenna, the second mobile communication antenna, the first WIFI antenna and the second WIFI antenna are provided to a first surface of the first metal plate respectively, the second metal plate is at least partially suspended relative to the first surface of the first metal plate.

15. The antenna device according to claim 3, wherein
the first WIFI antenna, the second WIFI antenna and the second metal plate and the first metal plate are integrally formed.

16. An antenna device comprising antenna radiating assembly, the antenna radiating assembly comprising:
a first metal plate comprising a first side edge, a second side edge, a third side edge and a fourth side edge;
a second metal plate integrally formed with the first metal plate and extending from the fourth side edge toward the first side edge and the second side edge;
a plurality of antennas comprising:
a first mobile communication antenna provided to the first side edge of the first metal plate;
a second mobile communication antenna provided to the second side edge of the first metal plate;
a first WIFI antenna and a second WIFI antenna respectively integrally formed with the first metal plate and bending inwardly from the third side edge of the first metal plate and extending to form metal stamping antennas.

17. The antenna device according to claim 16, wherein
the first mobile communication antenna and the second mobile communication antenna are a first LTE/5G antenna and a second LTE/5G antenna respectively.

18. The antenna device according to claim 17, wherein
the second metal plate comprises a connecting portion and a paralleling portion, the connecting portion is perpendicularly connected to the first metal plate, so as to make the paralleling portion suspended relative to a first surface of the first metal plate.

19. The antenna device according to claim 16, wherein
the first mobile communication antenna and the second mobile communication antenna are PCB antennas respectively, and are perpendicular to each other.

20. The antenna device according to claim 16, wherein
the first WIFI antenna and the second WIFI antenna are parallel to each other.

21. The antenna device according to claim 16, wherein
the first mobile communication antenna and the second mobile communication antenna each are a monopole plus parasitic antenna;
the first WIFI antenna and the second WIFI antenna each are an IFA plus parasitic antenna.

22. The antenna device according to claim 16, wherein
the antenna further comprises a GNSS antenna, the GNSS antenna comprises a GNSS circuit board which is provided to a first surface of the first metal plate and a GNSS antenna body which is provided to a second surface of the first metal plate.

23. The antenna device according to claim 16, wherein
the antenna device further comprises a plurality of coaxial cables, each coaxial cable corresponds to the corresponding antenna, a first end of the coaxial cable is connected to a radio frequency connector, a second end of the coaxial cable is electrically connected to the corresponding antenna;
the coaxial cable comprises an internal conductor and an external conductor, the internal conductor of the coaxial cable is soldered to a feed soldering pad of the corresponding antenna, the external conductor of the coaxial cable is soldered to the first metal plate.

24. The antenna device according to claim 23, wherein
the antenna device further comprises an outer casing, the antenna radiating assembly is accommodated inside the outer casing, a surface of the outer casing is provided with a rubber filler which allows the coaxial cables to pass through.
